(19) United States
(12) Patent Application Publication
(10) Pub. No.: US 2004/0220815 A1
(43) Pub. Date: Nov. 4, 2004

(54) Apparatus and method for the compilation, assembly, and distribution of product documentation and associated information

(76) Inventors: Johanne Belanger, Montreal (CA); Ozgen Eryasa, Montreal (CA); Normand Montour, Outremont (CA); Michel C. Ouellet, St-Bruno (CA); Herve C. Monnot, Laval (CA); Francoise Rivest, Longueuil (CA)

Correspondence Address: Smart & Biggar, CM, Suite 3400, 1000 de la Gauchetiere Street West, Montreal, QC, H3B 4W5, CA

(21) Appl. No.: 10/344,940

(22) PCT Filed: Aug. 20, 2001
(86) PCT No.: PCT/CA01/01194

Related U.S. Application Data
(63) Continuation of application No. 09/645,491, filed on Aug. 25, 2000, now abandoned.
(60) Provisional application No. 60/226,096, filed on Aug. 18, 2000.
(60) Provisional application No. 60/297,271, filed on Jun. 12, 2001.

(30) Foreign Application Priority Data
Mar. 28, 2001 (WO) PCT/CA01/00403

(51) Int. Cl. G06F 17/60

(52) U.S. Cl. 705/1

(57) ABSTRACT

An electronic document is generated in a highly automatic manner from a component part repository. Information blocks in the component part repository, such as information relating to a particular part in a engineering design, are stored instances of a common data model. The electronic document can be quickly and efficiently generated from the information blocks using scripting programs and document definition files designed to define the layout of the electronic manual. The tools used to create the electronic manual are highly re-useable and adaptable, allowing new documents for new customers to be created quickly and efficiently. Once created, a document may be distributed electronically over a network to the customer.

### FIELD OF THE INVENTION

The present invention generally relates to an apparatus and method for the collection, assembly, editing, and publication of information from a variety of independent sources. More specifically, the present invention concerns the compilation, assembly, publication, distribution and use of electronic information of a variety of types, including electronic manuals and product documentation.

### BACKGROUND OF THE INVENTION

When a product is delivered from a manufacturer to a customer, certain documentation is customarily supplied to the customer with the product. The documentation may encompass a broad spectrum of information, most commonly including technical manuals that describe the product in detail and instruction manuals for operating the product (when required).

Taking the purchase of an automobile as an example, a customer usually receives with his purchase several booklets, often referred to as the “owner's manuals.” The booklets may encompass a technical manual (or several manuals) describing the automobile and the equipment that accompanies it, an instruction booklet for the operation of the automobile and associated equipment, and possibly a booklet to assist in tracking the maintenance schedule for the vehicle.

The same type of documentation is provided whenever a manufacturer sells any complex product, such as a train locomotive or an airplane. However, in the case of complex products, the product literature that accompanies the product is usually much more extensive than that provided with an automobile.

The assembly of the documentation for these large-scale engineering projects is often expensive. The printed version of the product literature alone (such as the technical manuals) may encompass thousands of pages and incorporate product information from multiple vendors. Compiling, formatting, editing, and printing this information is often a time consuming and labor intensive task. For certain projects, the task may typically consume thousands of man-hours.

Product literature for complex products, such as passenger railway systems, may encompass a broad spectrum of documentation relating to topics such as the operation, repair, and maintenance of the product and the supporting infrastructure. Taking the example of a passenger railway system, the product literature generally includes a technical description, with one or more related drawings, of each part in the railway system. Additionally, because various parts in the system are manufactured and maintained by more than one vendor, specifications from each vendor must be independently obtained and incorporated into the final manual in order to create a useful and effective informational tool for the customer.

The production of this literature is made complex by the fact that the products may contain variations in components from one project to the next or from one customer to the next. While large portions of information may be reused for similar projects, the variations between individual projects must be accommodated.

The production of this technical literature is made even more complex by the fact that individual customers may require that the product information be presented in a particular format that is preferred by the customer.

For these reasons, the manufacturer often devotes considerable resources to the production of variations of the same product information, each variation tailored to the specific product and to specific customer's demands.

Accordingly, the party responsible for producing the product documentation (i.e., the manufacturer) is faced with the onerous task of gathering information about each of the components from each one of the vendors that supply the components. The manufacturer must also organize the individual parts descriptions and assemble the descriptions into a final document that presents the information in an easily accessible format for the customer.

Conventionally, each of these steps has been manually performed by an operator (or operators), using “cut and paste” techniques, to assemble and format the individual product inputs into the final product documentation. Under this system, creating new versions or adding revisions to the documentation is not a trivial task, as the manufacturer may be required to rewrite large sections of the technical literature provided with the product.

In addition, when multiple manuals are to be compiled that are different from one another but related (such as a parts catalog and a parts maintenance manual for the same project), conventional methods require that the related manuals be assembled and formatted separately and independently, even though there may be significant information common to both. This results in a substantial duplication of effort and an undesirable waste of resources.

The assembly of the information received from vendors is even more complex when the information is provided in an electronic form, because each of the various vendors may use different formatting and presentation standards for the information that they supply. This complicates the task of assembling a final unified document, because the different information formats must be accommodated before the final documentation may be assembled.

In addition, the assembly of this information from vendors is further complicated when the vendors supply electronic information such as audio, video, photographic, audiovisual, motion picture, engineering schematic, or multimedia components. Understandably, if each vendor supplies these components in a different format, the assembly of the final, unified document becomes even more burdensome.

From all of this, a need has developed to more efficiently generate and distribute product literature, documentation and information, including technical manuals. In addition, a need has developed for a system that is capable of reusing information, tools, techniques, and assembly methods that are common to individual projects or products, while allowing each project to be tailored and customized to meet the specific needs of the individual customer. This is especially true where the product information is in an electronic form.

### SUMMARY OF THE INVENTION

The present invention addresses the needs that have developed for the generation and distribution of product literature, documentation and information, including technical manuals.

Specifically, systems and methods consistent with the principles of the present invention address the needs identified above by providing an improved system for gathering, assembling and distributing product literature, documentation and information, such as technical manuals.

Therefore, in accordance with the present invention, it is an object to provide a method of compiling, assembling and distributing a technical document relating to a project. The method includes receiving component part information describing information for the technical document from a plurality of vendors, where each of the vendors is responsible for documenting a portion of the project. The received component part information is stored at a central location. Automatically, at least a portion of the technical document is generated by retrieving and organizing elements of the stored component part information. The retrieving and organizing operations are based on a file describing the desired structure of the technical document. Finally, the technical document is distributed to the customer.

In a particular aspect, the method further includes, prior to the receiving of component part information, guiding the preparation of component part information by the vendors. In particular, preparation of the component part information is effected by a guided authoring tool implemented on a computing platform, which guides the preparation of the component part information on a basis of a structured document model file. The latter defines at least in part a structural layout of text in the component part information. Thus, the respective component part information submitted by each of the plurality of vendors conforms to the common structured document model file. The method also includes validating the component part information submitted by each of the vendors, as well as preventing the vendors from modifying the structured document model file. The validation of the component part information includes verifying that the component part information submitted does in fact conform to the predefined structured document model file. In a specific example, the predefined structured document model file is a Document Type Definition (DTD) of the SGML (Standard Generalized Markup Language) format.

In another aspect, each of the plurality of vendors is associated with a user profile defining the vendor access rights. Accordingly, the method further includes the step of authorizing a particular vendor to submit component part information at least in part on a basis of the user profile associated with the particular vendor. Thus, a particular vendor is restricted from submitting new component part information or maintaining previously stored component part information that is not relevant to the particular project for which the particular vendor is responsible.

It is another object of the present invention to provide a document center, which includes a data acquisition component configured to receive, from a plurality of vendors, component part information describing information relating to a project. Each vendor is responsible for documenting a portion of the project. A component part repository is coupled to the data acquisition component and stores the received component part information. A publication engine is coupled to the component part repository for automatically generating at least a portion of a technical document describing the project by retrieving and organizing elements in the component part repository. The retrieval and organization of the document is based on a file describing the desired structure of the technical document. Finally, a distribution component is provided for distributing the structured electronic document to a customer.

In a particular aspect, the document center includes an editor coupled to the component part repository. This editor allows operators of the document center to modify the stored component part information in the component part repository.

In another aspect, the data acquisition component of the document center includes a guided authoring module. This guided authoring module is operative to guide each of the vendors in the preparation of the component part information for submission to the document center, on a basis of a structured document model file, such as an SGML DTD. The data acquisition component is operative to prevent any one of the vendors from modifying the structured document model file, such that all the component part information received from each vendor is prepared on the basis of a common structured document model file.

In yet another aspect, the data acquisition component includes a validator module for validating the component part information submitted by the vendors. This validator module verifies that the component part information conforms to the predefined structured document model file, and verifies the nomenclature and coherency of the text in the component part information.

It is still another object of the present invention to provide a method of producing a technical manual describing an engineering project. The method includes storing a plurality of Standard Generalized Markup Language (SGML) files, where each of the files relates to at least one aspect of the engineering project. The method further includes assembling information from select ones of the plurality of SGML files into the technical manual based on pre-defined files describing the desired structure and content of the technical manual. The SGML files include information describing at least one of parts used in the engineering product or maintenance schedules relating to the described parts.

Other objects of the present invention will be made apparent from the drawings and detailed description that follow.

### BRIEF DESCRIPTION OF THE DRAWINGS

The accompanying drawings, which are incorporated in and constitute a part of this specification, illustrate an embodiment of the invention and, together with the description, explain the objects, advantages and principles of the invention. In the drawings:

FIG. 1 is a block diagram of an exemplary network on which product documentation (such as an electronic manual) can be compiled, assembled and distributed consistent with the teachings of the present invention;

FIG. 2 is a high-level flow chart illustrating the creation and distribution of the product documentation (i.e., the electronic manual);

FIG. 3 is block diagram illustrating an exemplary implementation of the document center;

FIG. 4 is a diagram illustrating the functional components of the data acquisition source component of the document center;

FIG. 5 is a diagram illustrating the functional sections of the equipment list maintenance component;

FIG. 6 is a diagram illustrating the main functional aspects of the vendor information blocks environment component;

FIG. 7 is a diagram summarizing the types of information that may be exchanged between the components in a system consistent with the present invention;

FIG. 8 is a flow diagram illustrating exemplary processes consistent with the present invention;

FIG. 9 is a high-level diagram illustrating the integration of various business divisions with vendors and customers; and

FIG. 10 is a high-level diagram illustrating interaction of outside parties with a system including the document center.

### DETAILED DESCRIPTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather, the scope of the invention is defined by the appended claims.

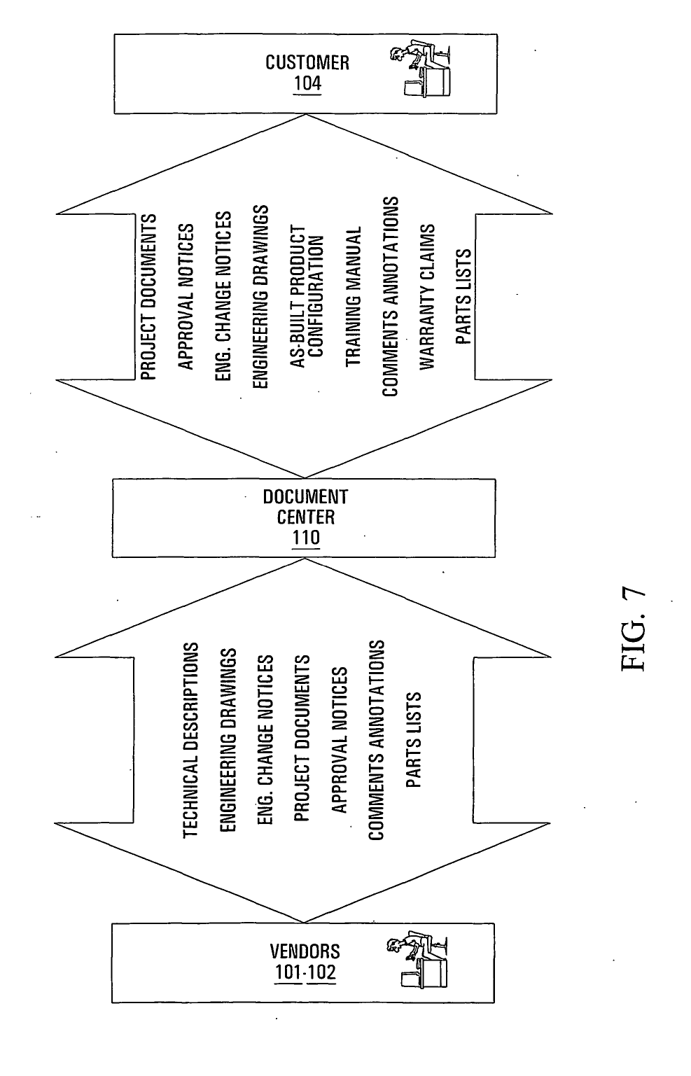

An electronic document including many aspects of product documentation, such as an electronic manual, is described herein. While the following description focuses on the production of electronic manuals, it should be understood that the term “electronic manuals” is not meant to encompass technical manuals only. Instead, reference to an “electronic document” or on “electronic manual” is meant to encompass any aspect of product documentation and related information that may be assembled for a product with which the information is associated. In this regard, FIG. 7 is exemplary, but not limiting, of the type of information that is meant to be encompassed by the scope of the present invention.

According to the present invention, the product documentation is generated in a highly automatic manner from a component part repository. Information blocks in the component part repository, such as information relating to a particular part in an engineering design, are stored instances of a common data model. The electronic manual can be quickly and efficiently generated from the information blocks using scripting programs and document definition files designed to define the layout of the electronic manual.

The tools used to create the electronic manual are highly re-useable and adaptable, allowing new manuals for new customers to be created quickly and efficiently. The product documentation may be provided as an interactive electronic manual (IEM), standardized interchange formats (e.g., in the case of a railway product, EPCES from the Rail Industry Forum (RIF)), a printed document, a database input, or outputs to databases, to name a few examples encompassed by the present invention.

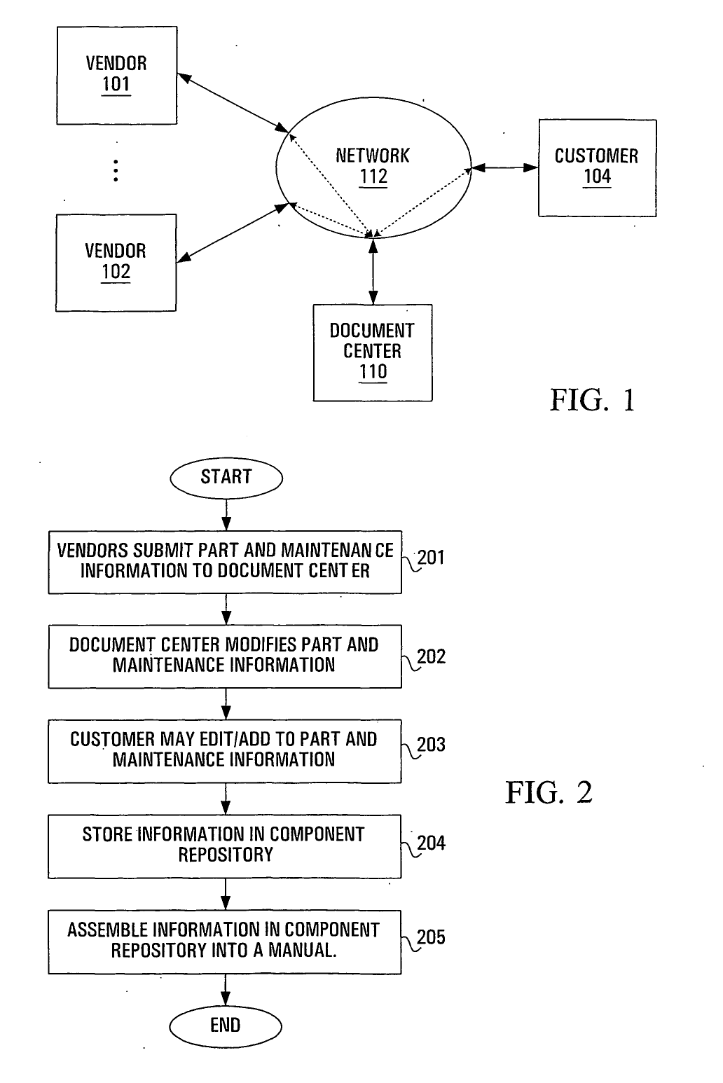

FIG. 1 is a block diagram of an exemplary network on which the electronic manual consistent with the present invention can be assembled and distributed.

Document center 110 is a collection of programs, methods, tools, networks and computers that help to generate and manage the electronic manual. Document center 110 involves the interaction of methods, interfaces, procedures, transformation programs and software for its operation. Document center 110 is implemented within or by the company or organization that is taking the lead role in the production of the electronic manual (i.e., the manufacturer of a product). Typically, document center 110 may be maintained by a technical publication and/or information services department of the company or organization.

Document center 110 can communicate with vendors 101-102 and customer 104 via network 112. Network 112 may be, for example, the Internet.

In a typical situation, each one of a plurality of vendors 101-102 is responsible for a portion of the electronic manual. While reference is made to only two vendors herein, those skilled in the art will readily recognize that the number of vendors 101-102 may be far greater than two. In an electronic manual to be produced as part of a large engineering project, for example, each of vendors 101-102 may be responsible for a particular portion of the project and for the documentation corresponding to their portion. The final technical manual is to be delivered to customer 104 by the organization implementing document center 110.

FIG. 2 is a high-level flow chart illustrating creation and distribution of an electronic manual.

Documentation relating to each portion of the project is collected in a component part repository at document center 110. More specifically, vendors 101-102 submit part information and maintenance information to document center 110 via network 112 (act 201). Document center 110 may itself generate and submit information relating to the project, or edit previously submitted information (act 202). More particularly, document center 110 can enrich the existing information by, for example, adding hyperlinks, navigational information and hotspot information (e.g. to graphics). Document center 110 may also link specific information (i.e., the hotspots) to other information, such as related text or parts lists. Furthermore, document center 110 tracks and manages changes in the various versions of the product information and prepares the information for a specific output format (e.g., paper, IEM, EPCES, etc.). Media-specific information may also be added by document center 110, depending on the output format. For example, document center 110 may add a table of contents, page information, page breaks, a table of contents for hyperlinks, search indices and navigational information, among others.

Additionally, the end customer may contribute to the electronic document (act 203). The customer may, for example, submit information such as customer part numbers or submit feedback or additions to a current version of the electronic manual.

The document center 110 is operative to guide any submission of information during acts 201-203, such that the information submitted is in the form of a predefined structured document model, common to submission by vendor, customer or document center 100. All of the information submitted during acts 201-203 is stored in an information component repository (act 204), the information blocks in the component repository containing tags that describe the content of the information blocks. The tags are applied pursuant to the predefined structured document model, as will be described in further detail below. An example of such a structured document model is an SGML (Standard Generalized Markup Language) Document Type Definition (DTD).

When a decision is made to publish, the operators at the document center 110 assemble the manual with the help of scripts and data files that are defined to generate the desired formatting and organization of the manual (act 205). The final manual can be printed or made available electronically to customer 104.

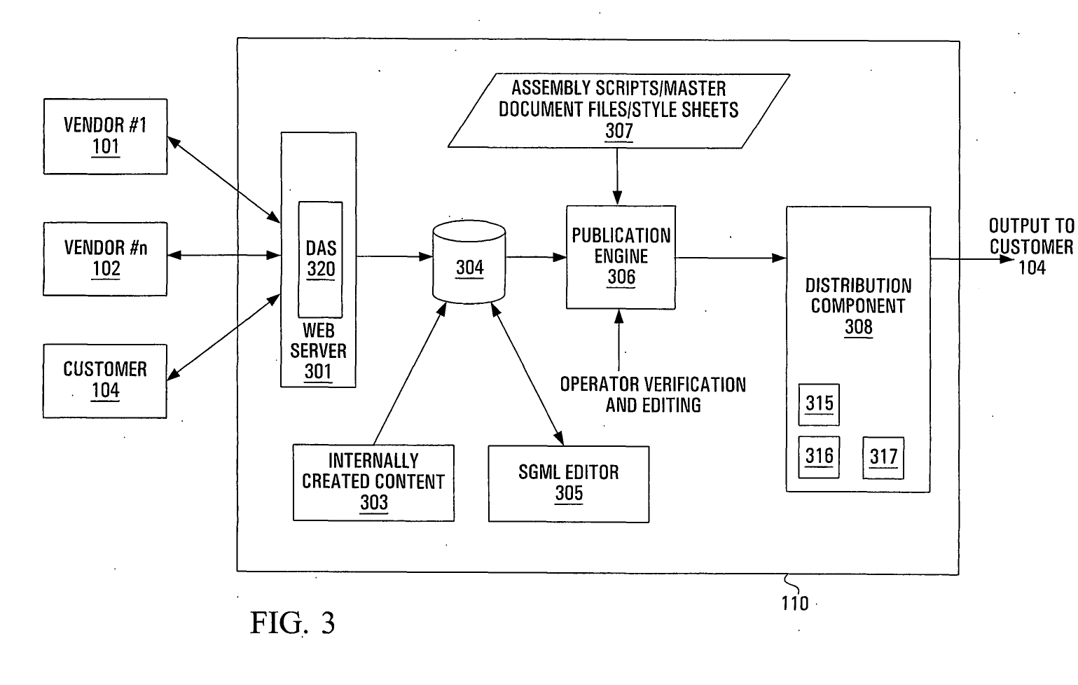

FIG. 3 is block diagram illustrating an exemplary implementation of document center 110.

Vendors 101 and 102 interface with document center 110 through the data acquisition source (DAS) component 320, running on web server 301. Customer 104 may similarly communicate with document center 110 through web server 301 to enter information relating to its project. DAS 320 is a web application through which vendors 101-102 submit data related to their portion of the engineering project to the document center 110. DAS 320 presents an electronic environment that assists vendors in writing, assembling, verifying, and submitting the required material.

Web server 301 is a computer server, or network of computer servers, executing a web serving program, such as an EDMS (electronic data management system) program. Web serving programs are well known in the computer art. Computer servers equipped with web serving programs are commercially available from a number of companies, such as the “Domino” family of server programs, available from Lotus Corporation.

One of the features of the web serving program executed by the web server 301 is a security mechanism operative to ensure a secure electronic environment and to authenticate system users. In a specific example, such a security mechanism includes a 40 or 128-bit encryption/decryption scheme as well as intrusion detection capability. In particular, vendors are pre-certified by document center 110 as being authorized vendors, each pre-certified vendor being associated with an exclusive system account and a respective user name and password. Upon attempting to log in to web server 301, a vendor is prompted by the web server 301 interface to provide a user name as well as a password. The security mechanism implemented by the web serving program is operative to attempt to authenticate the vendor on a basis of the user name and password provided upon log-in. If the vendor is authenticated by the security mechanism, the log-in process is completed. Alternatively, the log-in process is aborted and the vendor is refused access to the document center 110, due to an invalid vendor identification.

Each pre-certified vendor is also associated with a particular user profile defining the access rights of the vendor. Thus, various levels of control are available to the vendors with regard to the authoring of material and release of information to the DAS 320. In one example, each user account is associated with one of three possible levels of control, notably Read-only, Edit or Release. A user profile defining “Read-only” access rights permits the vendor to read and print data stored in the document center 110. A user profile defining “Edit” access rights permits the vendor to author new information and to modify information already stored in the document center 110. A user profile defining “Release” access rights permits the vendor to release information submitted to the document center 110 for use by the document center 110 in assembling the manual.

In another example, the user profile defines a specific subset of information to which the vendor has access, thus restricting the access rights of the vendor. Assume that, on a given engineering project, a particular vendor is responsible for a certain set of parts. Thus, when the vendor logs in to the web server 301, the vendor is authorized by the security mechanism to only input or manipulate documentation directed to the certain set of parts, on a basis of the predefined user profile associated with the particular vendor's account. Should the vendor attempt to input or manipulate information other than that directed to the certain set of parts, the action will be refused by the security mechanism of the web serving program and an “Access Denied” message will be transmitted to the vendor.

Documentation received from vendors 101-102 is stored in component part repository 304. Additional documentation may be added, adjusted, edited, or generated internally to document center 110. This is illustrated by the component 303 in FIG. 3, labeled “Internally Created Content.”

Editor 305 accesses the information in component part repository 304. Through editor 305, information in component part repository 304 can be viewed and edited by the document center 110. In practice, technical writers or other staff members at document center 110 often edit or add to the information in component part repository 304. In a specific example, the editor 305 is an SGML-based editor, such as the “FrameMaker+SGML” software package available from Adobe Corporation of San Jose, Calif.

Publication engine 306 generates customized technical manuals or other documents from the information stored in component part repository 304. The order of the information components in the generated manual and a description of the presentation of the components is specified by a master document file (or files) that is read by assembly scripts 307 and input to publication engine 306. More particularly, publication engine 306 executes scripts that perform basic document assembly operations, such as compiling a document from its component parts and indexing the compiled document to generate an index. The intended organization of the component parts is read by the scripts from the master document file, which is prepared by operators at document center 110. Publication engine 306 may additionally apply styles to refine the presentation style (e.g., fonts, etc.) of the manual. Although the generation of the electronic manual is largely automated, the manual can also be viewed, verified, or refined by human operators.

As was previously mentioned, manuals generated by publication engine 306 may be simultaneously distributed to customer 104 in a variety of formats (e.g., printed, on CD-ROM, electronically via network 112, etc.). Distribution component 308, which is described in more detail below, enables distribution of the manual to customer 104.

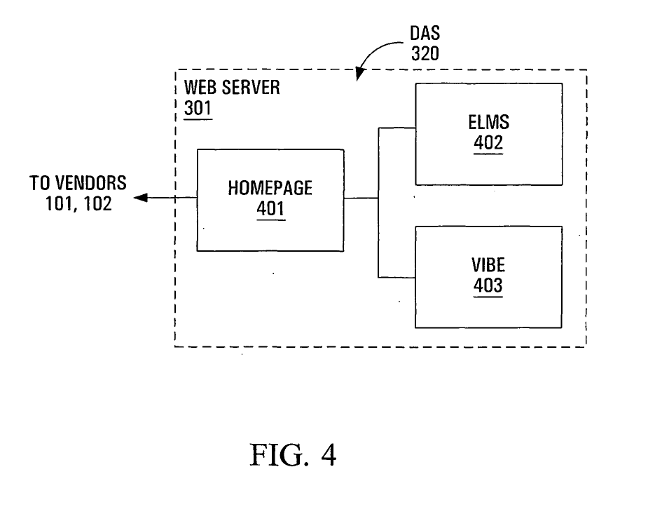

Additional details of the components in document center 110 will now be described with reference to FIGS. 4-6.

FIG. 4 is a diagram illustrating the functional components of the DAS component 320. In general, DAS component 320 provides a web-based environment in which vendors 101-102 can interact and enter their part data. Vendors visiting DAS component 320 are initially presented with a web page, shown as homepage 401. Through homepage 401, vendors may logon and authenticate themselves to web server 301. The homepage 401 also posts messages intended for the vendors/authors.

In a specific example of implementation, the homepage 401 is the access point for several on-line services, such as a Vendor Work Instructions (VWI) manual, a legal disclaimer, an on-line help tool and all system Access Request forms. The VWI manual and the Access Request forms are stored as downloadable documents, for example .pdf documents, that can be downloaded to the vendor's workstation. Although the VWI manual and the on-line help tool are practical to help the vendor in using the system and submitting information to the document center 110, a technician-manned Help Desk may exist as an additional source of aide to the system users. The Help Desk specifically caters to vendors for quick answers to common user problems. In this case, the homepage 401 also contains phone and fax numbers to the Help Desk, as well as e-mail coordinates.

Through homepage 401, vendors can access the ELMS (Equipment List Management System) component 402 and the VIBE (Vendor Information Block Environment) component 403 of the DAS component 320. ELMS component 402 allows vendors to enter basic information pertaining to their parts lists. Additionally, through ELMS component 402, information concerning maintenance, such as tasks relating to required tools, job-skills and training, is entered. Thus, ELMS component 402 forms the backbone of the system by controlling the parts database and the list of the maintenance procedures associated to each maintainable part. VIBE component 403 allows vendors to enter the detailed textual and graphical information that describes parts provided by each particular vendor.

Vendors use ELMS component 402 to perform three main functions: (1) identify parts; (2) identify operations on maintainable parts and the relationship between the maintainable parts and any related maintenance tasks; and (3) identify parts that are replaceable parts. As used herein, a maintainable part is a part that requires maintenance. A replaceable part, in contrast, refers to a part that has to be replaced, bought, and stocked in inventory.

ELMS component 402 may be implemented as a Java applet transmitted, on request, to vendors 101-102. In this implementation, the ELMS Java applet runs on the vendor's computer and transmits information entered by the vendor back to document center 110. A windows-like interface is provided by the ELMS component 402 to the vendor, permitting easy data entry and a user-friendly parts assembling environment. Further, ELMS component 402 is capable to perform standard on-the-fly validation of the information submitted by a vendor, in order to prevent duplication of data and other such mistakes. Such standard on-the-fly validation functionality is well known to those skilled in the art, being common to most word processing software, and as such will not be described in further detail.

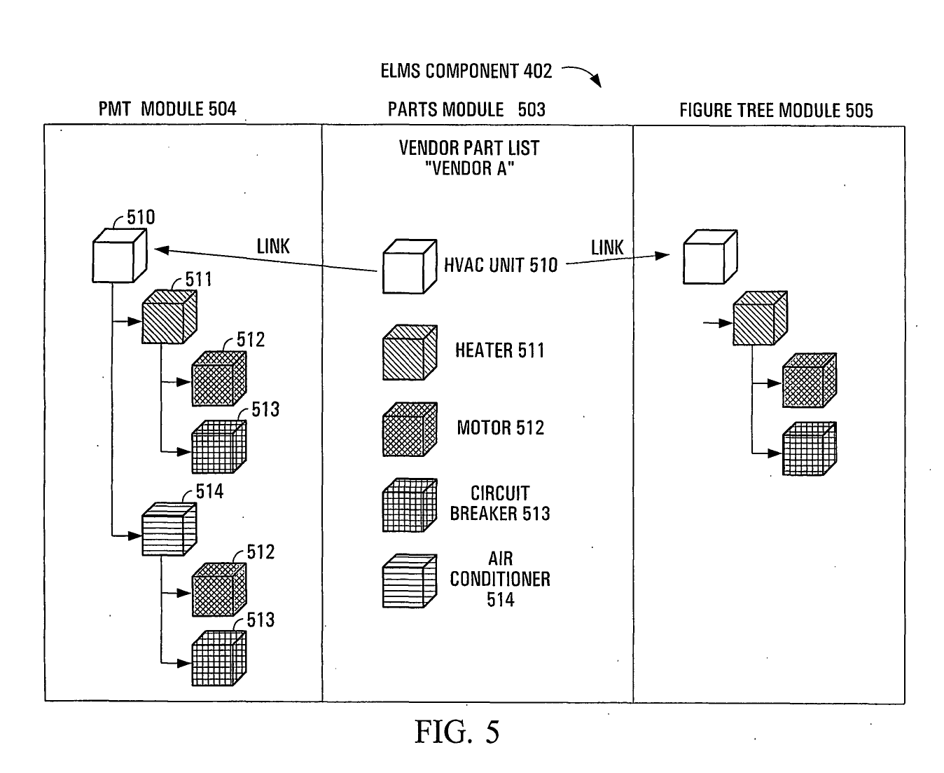

FIG. 5 is a diagram illustrating the three main functional sections of ELMS component 402: parts module 503, parts maintenance tree (PMT) module 504, and figure tree (FT) module 505. Vendors input to parts module 503 lists of parts for which they are responsible. The list may include, for example, parts used in the final engineering design and parts used as special tools or test equipment in the design. The list of parts input to parts component 503 is not structured; rather, it is a flat list of parts for a particular vendor.

A vendor may input parts one by one to the parts module 503, or may initiate a batch upload of parts to the parts module 503 from an existing file, via an import module of the ELMS component 402. During a batch upload of parts, the import module provides an interface to the vendor that prompts the vendor for information relating to the file to be imported, such as its file name and location. Possible locations for the file include the hard and floppy drives of the vendor's computer, as well as a server drive to which the vendor's computer may be connected via a data network. Similarly, a vendor may initiate a batch download of parts from the parts module 503 to a local file, via an export module of the ELMS component 402.

Each part input by the vendor is uniquely identified by a part number. Additional information may be input for each part, such as a description of the part, vendor or builder part numbers or codes, and whether the part is commercially available on the open market.

Parts module 503 shown in FIG. 5 contains an exemplary list of vendor entered parts, including HVAC unit 510, heater 511, motor 512, circuit breaker 513 and air conditioner 514.

Parts listed in the parts module 503 are assembled in the PMT module 504 using a maintenance-based hierarchy. More specifically, in the PMT module 504, vendors define maintenance requirements for the parts in their part list(s). The same part, in different structural locations, may require different maintenance procedures due to, for example, different access procedures or more stringent use. Thus, maintainable items in PMT module 504 are organized in a hierarchical manner based on the relationship of a particular part to its structural location in a larger component and its maintenance requirements, where the maintenance structure is created based on the list of parts in the parts module 503.

As shown in the example of FIG. 5, the maintenance structure for HVAC unit 510 includes heater component 511 and air conditioner component 514. Each of heater 511 and air conditioner 514 are further defined by a motor 512 and a circuit breaker 513. Each instance of the components 510-514 in the PMT module 504 is linked to the primary description of the part in the part list and is associated with maintenance related information specific to that instance of the part. The maintenance related information may include, for example: a maintenance ID number permitting tracking and validation of the part, expected service life, time required to inspect, and the mean time to repair, among other possibilities. Alternatively, if the part is a replaceable item, this fact is entered in the description.

The figure tree module 505 is where the parts are assembled using a parts catalog-based hierarchy. More specifically, FT module 505 illustrates a hierarchical list of replaceable parts, replaceable assemblies, and replaceable sub-assemblies and links them to an illustration file. As with the PMT module 504, entries in the FT module 505 are arranged hierarchically based on the components in the parts list. By linking illustrations hierarchically, end user's can “drill down” into an illustration to obtain more detailed information about a specific portion of the illustration. In sum, vendors use FT module 505 to define the relationship between illustrations of parts. Actual creation of and entry of the illustrations, however, is accomplished with VIBE component 403.

In a specific example, the structure of the figure tree follows a functional system-by-system breakdown, down to the lowest-level replaceable assembly. Next, the component and sub-component items are added, down to the lowest replaceable component. Each illustration in the figure tree is associated with a vendor figure number, an illustration file name and a figure title. By accessing the figure tree via the FT module 505, a vendor may add, modify and delete figure records, as well as enter reference information for illustration files. Further, a vendor may add, modify, delete and indent figure assemblies, components and items, as well as import and export figures.

Note that parts in the parts module 503, PMT module 504 and FT module 505 are internally linked, such that changing a characteristic of a part in one of components 503-505 correspondingly affects instances of the part in the other of the components 503-505.

In addition to internally linking various illustrations in a project, text related to an illustration may be linked to the illustration. Thus, the textual information relating to a part may include tags identifying an illustration, or a component in an illustration. Similarly, illustrations can contain tags identifying textual information related to the illustration. This allows publication engine 306 to generate electronic manuals with hyperlinks allowing users to jump between the textual description and the graphical illustration for a part.

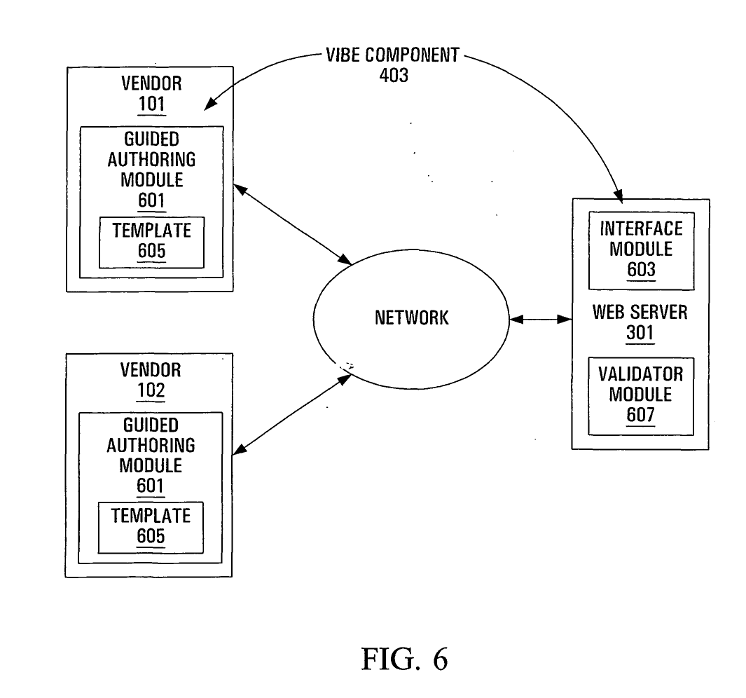

FIG. 6 is a diagram illustrating the main functional aspects of VIBE component 403, which includes two modules: a web interface module 603 for the management of information blocks and a validator module 607. In brief, VIBE component 403 provides vendors with guided document management authoring tools that allow vendors 101-102 to enter substantive part information in a format consistent for all vendors. In contrast to ELMS component 402, through which vendors enter basic part information and information directed to the relationships between parts, VIBE component 403 allows the vendors to create the detailed textual and graphical information describing the parts.

In order to ensure consistency across multiple vendors, each of the participating vendors creates their documentation using a guided authoring module. As shown in FIG. 6, a local instance of the guided authoring module 601 is installed at each of vendors 101-102, including a set of templates 605. Information entered at vendors 101-102 via the authoring module 601 is uploaded to web server 301 of document center 110.

The guided authoring module 601 guides the vendor throughout the entire process of creating, editing, submitting and revising of documentation, on the basis of a structured document model file describing the structure of the documentation, including the text layout of the documentation. The guided authoring module 601 ensures that the information submitted by the vendor conforms to this predefined structured document model file. In a specific example of implementation, the guided authoring module 601 guides the vendor by strictly limiting the operations performed by the vendor to insertions of valid elements into the document being created, edited or revised. Thus, the burden of formatting the authored information is removed from the vendor, and performed entirely by the guided authoring module 601. Note that the setup of the guided authoring module 601 is inaccessible to the vendor, such that the vendor is restricted from modifying in any way the predefined structured document model file, and thus the guidelines provided by the guided authoring module 601. Thus, all information submitted to the DAS 320 by vendors conforms to the predefined structured document model file as enforced by the guided authoring module 601.

Accordingly, the guided authoring module 601 allows a vendor to create information blocks describing the parts for which that vendor is responsible. Each information block entered by a vendor is associated with an identification number that links the block to the parts list entered previously by the vendor via the ELMS component 402. The vendor uploads the information blocks, including the identification number, to the web server 301.

Note that the information blocks submitted by a vendor can include audio or video files, as well as standard text and graphics. For example, an information block can include SGML text, CGM4 illustrations, 3-D graphics, etc.

The web interface module 603 and the validator module 607 are installed on the web server 301, the web interface module 603 being implemented by the homepage 401. The web interface module 603 is a specially configured interface used for well-known electronic document management functions, while the validator unit 607 is operative to enforce the specific. authoring rules established by the DAS 320, including those defined by the guided authoring module 601. The modules 603 and 607 thus provide for the validation of information submitted to the DAS 320 by the vendor, via the guided authoring module 601 of the VIBE component 403, ensuring that this information is electronically and structurally valid.

In a specific example of implementation, the guided authoring module 601 is implemented using a customized version of the “FrameMaker+SGML” software package, available from Adobe Corporation. The “FrameMaker+SGML” application allows templates 605 to be used to create documents having a highly structured composition. A Software Developer's Kit, also available from Adobe Corporation, is used to customize the standard “FrameMaker+SGML” software in order to configure it to the needs of the DAS 320. It is important to note that other markup description languages, such as XML (extensible markup language), could be used in place of SGML.

In general, SGML (Standard Generalized Markup Language) is a well-known international standard (ISO 8879, 1986) that permits the creation of documents that are independent of any specific hardware or software, by prescribing a standard format for embedding descriptive markup within a document. Descriptive markup describes the semantic nature of the text in a document, rather than its physical appearance on the page. Descriptive markup is based on the structure of a document and identifies elements within that structure—such as a chapter, a section, an abstract, or a table—using notations that describe what the element is, and not how it appears. SGML also specifies a standard method for describing the structure of a document. In other words, SGML allows the user to set up hierarchical models for each type of document produced. SGML forces each element in the structure, which is labeled with a descriptive markup tag, to fit in the logical structure of the document. At the heart of an SGML application is a file called the Document Type Definition (DTD) that describes the structure of a document and provides a framework for the elements (such as chapters and chapter headings, sections and topics) that constitute the document. A DTD also specifies rules for the relationships between elements, such as “a chapter heading must be the first element after the start of a chapter” or “each list must contain at least two items.” These rules, which the DTD defines, help ensure that documents have a consistent, logical structure. A DTD accompanies a document wherever it goes. The content of a document includes titles, paragraphs, lists, tables, graphics and audio. The method for identifying the content's position within the DTD structure is called “tagging”. Creating an SGML document involves inserting tags around content. These tags mark the beginning and end of each part of the structure.

In order to prevent unauthorized modifications by the vendor to the DTD of the “FrameMaker+SGML” application, in particular to the rules or structure specified by the DTD, authoring configuration files are installed on each vendor workstation 101, 102. These authoring configuration files customize the “FrameMaker+SGML” application such that the interface appearing to the vendor is a minimal one that guides the authoring process, thus promoting efficiency. More specifically, the authoring configuration files ensure that certain standard tools/dialogs permitting modification of the DTD are removed from the “FrameMaker+SGML” application, such that they are unavailable to the vendor. The vendor thus has no choice but to be guided by the customized “FrameMaker+SGML” application in order to author a document, possibility of control over the software application by the vendor having been removed by the authoring configuration files.

The templates 605 of the customized “FrameMaker+SGML” application are designed based on an SGML DTD provided by document center 110, as selected by the product manufacturer. The resultant data entered by the vendor is thus output in SGML format according to this same selected DTD. The templates 605 downloaded from document center 110 to the vendor workstations 101, 102 may be additionally customized for each vendor, such that the guided authoring module 601 contains narratives related to the information for which a particular vendor is responsible.

Hereinafter, reference will be made to the above described specific example of implementation in which the guided authoring module 601 is implemented using a customized version of the “FrameMaker+SGML” software, for illustration purposes.

The validator module 607 of VIBE component 403 is operative to verify, for each information block submitted by a vendor to the DAS 320 via the guided authoring module 601, certain criteria, such as:

Validity of the SGML structure as compared to the predefined DTD. In other words, the validator module 607 checks to make sure that the information block is properly configured and that the appropriate DTD was used by the vendor 101 in creating the information block. In a specific example, when an information block is created and submitted by a vendor to the DAS 320 using the appropriate DTD, the guided authoring module 601 stamps the information block with a predetermined identifier, confirming a valid configuration for the information block. The validator module 607 thus searches the submitted information block for the presence of this predetermined identifier, in order to validate the information block.

Validity of the content of the information block, including the nomenclature of parts and coherence with the PMT module 504. The validator module 607 checks the information block content to verify the structural layout of parts, the part numbers, the part number tags and the existence of part(s) in the PMT module 504, among other possibilities. In order to do so, the validator module 607 is operative to compare the data in the information block against the list of parts previously downloaded to the system via the ELMS component 402, with reference to the existing contents of the parts module 503, the PMT module 504 and the FT module 505.

Validity of the references to maintenance procedures. The validator module 607 checks the validity of any references to maintenance procedures contained within the information block, by consulting the vendor-defined part maintenance requirements defined in the PMT module 504. It is possible that a reference to a maintenance procedure in the information block is in contradiction with previously defined maintenance-related information stored in the PMT module 504.

Presence of a release number letter. Upon submission of data to the DAS 320 by a vendor, the data must be assigned a release letter number, for tracking purposes. In a specific example, the vendor is prompted by the guided authoring module 601 to assign a release number to an information block that has been prepared for submission to the DAS 320. The validator module 607 thus searches the submitted information block for the presence of a release letter number, in order to validate the information block.

Note that the above list of criteria is not exhaustive. The validator module 607 may be operative to verify many other possible criteria, without departing from the scope of the present invention.

The validator module 607 may determine that the information block submitted by a vendor is invalid, for example if the information block is not stamped with the predetermined identifier or if there is a lack of coherence with the PMT module 504. In such a situation, the validator module 607 is operative to refuse the invalid data and to return this invalid data to the vendor with a “Data Invalid” error message.

When an information block is successfully validated by the validator module 607, this information block is qualified as “released” and a “Data Valid” message is transmitted to the vendor. Thus, valid data is permitted by the validator module 607 of the VIBE component 403 to enter the DAS 320, for eventual integration into the electronic manual. Note that, upon “release” of an information block from a vendor to the DAS 320, as allowed by the validator module 607, the information block is data stamped, in order to allow subsequent tracking and versioning.

As described above, DAS component 320 of document center 110 allows vendors to easily submit and maintain documentation relevant to a portion of a project for which they are responsible. The component information is generated as SGML files having a document type definition (DTD) designed to store the types of data required for the particular project.

The SGML component files from vendors 101-102 are stored in the component part repository 304. Through editor 305, the SGML components in repository 304 can be viewed and edited. SGML editors are well known and are commercially available. One appropriate SGML editor is available in the “FrameMaker+SGML” software package, available from Adobe Corporation.

By storing all of the information required for a technical manual as SGML components in component part repository 304, a complete technical manual can be quickly and easy assembled. Since SGML divides data objects into discrete elements of information based on the content of the information, the components can be efficiently re-used and modified. Further, different manuals, targeted for different audiences or arranged for different purposes, can be generated based on the same information in component part repository 304.

As previously described, publishing engine 306 assembles the SGML components in the component part repository 304 to obtain a complete technical document. The final document may then be output to the customer via distribution component 308, which is a multi-channel publisher capable of producing the final document as either an on-line manual, a printed manual, an electronic manual stored on CD-ROM, or an interactive electronic manual, among other possibilities. These various potential aspects for distribution are illustrated in FIG. 3 by sub-components 315-317 of distribution component 308, including on-line interactive electronic manual sub-component 315, printing sub-component 316 and CD-ROM sub-component 317. However, the sub-components are not limited to those listed and may include a web server, among others. Each of sub-components 315-317 handles final formatting for distribution in its respective medium.

Distribution component 308 may include a web server from which customer 104 requests portions of the electronic manual. Suitable applications for electronically publishing an electronic document are known in the art. One suitable publishing application is “Insight” by Enigma Software Corporation, of Burlington, Mass. Insight creates a document database that can be translated dynamically to customer 104 as a combination of HTML, Java, and ActiveX programs. The database can be electronically searched by keyword, thus making the electronic manual more interactive.

By providing an electronic version of the manual to customer 104 via distribution component 308, additional value-added services can be offered to customer 104. For example, the electronic version of the manual can be linked to business systems internal to the customer. Accordingly, the customer 104 can order spare parts with the click of a button when viewing an electronic spare parts manual. In this situation, the spare part request could be received and processed by distribution component 308. Further, distribution component 308 may be linked to customer inventory data or other ERP (enterprise resource planning) related databases or programs.

FIG. 7 is a diagram summarizing the information exchange between the components in a system consistent with the present invention. As shown, both vendors 101-102 and customers 104 communicate with the document center 110. The vendors 101-102 and the document center 110 typically communicate information such as: technical descriptions, engineering drawings, engineering change notices, project documents, approval notices, comments, annotations, and parts lists. Similarly, customers 104 and the document center 110 typically communicate information such as: project documents, approval notices, engineering change notices, engineering drawings, as-build product configurations, training manuals, comments and annotations to the technical manuals, warranty claims, and part lists.

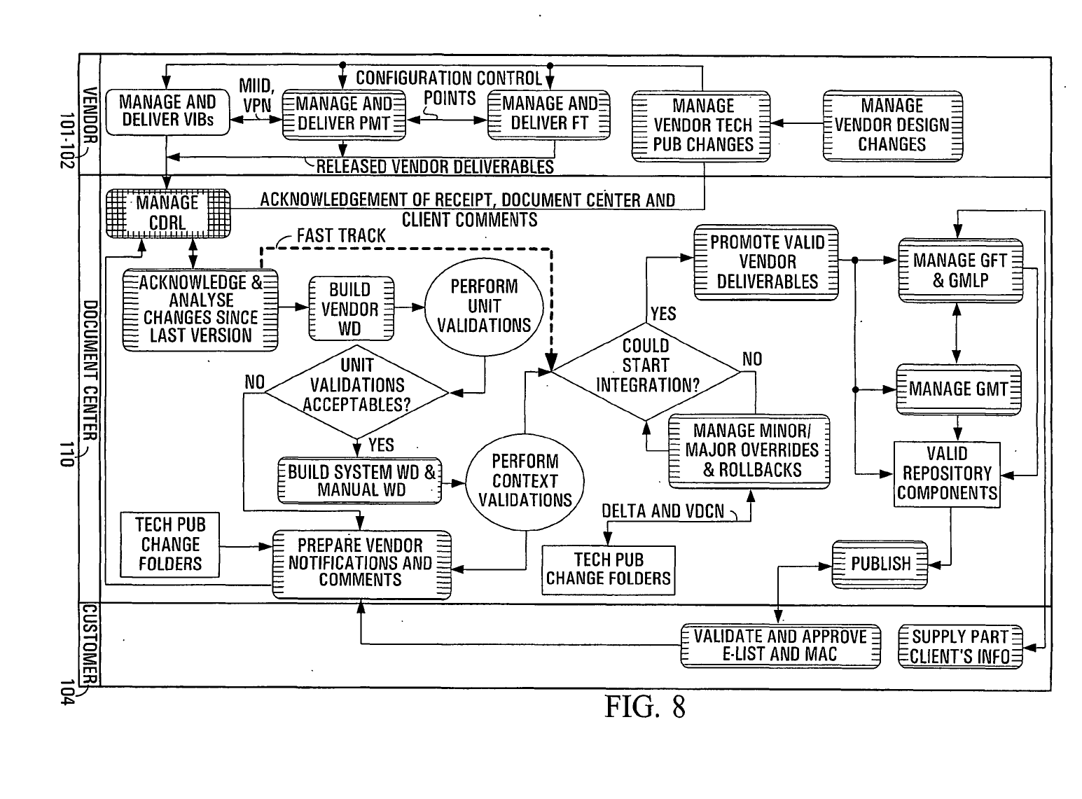

FIG. 8 is a flow diagram illustrating exemplary processes consistent with the present invention. In more detail, FIG. 8 illustrates exemplary processes performed at the vendor site 101-102, at the document center 110, and at the customer 104. As previously described, the vendor manages the creation and editing of the vendor part list, the part maintenance tree and the figure tree, strictly guided by the guided authoring module 601 of the document center 110. The portions of a project that the vendor 101-102 is responsible for are described by a contractual data requirement list.

Information received from the vendor 101-102 by document center 110 is validated, as described above. Validation refers to the process of ensuring that information received is characterized by a valid SGML structure as compared to the predefined DTD. Validation also involves ensuring that the SGML files received from the vendor 101-102 are internally consistent (i.e., the parts are described appropriately), as well as consistent in a global context. Global consistency refers to, for example, checking that parts are described with consistent terminology and that the version of a part description matches the version of the illustration.

Table I, below, is a legend describing the acronyms used in FIG. 8.

TABLE I

| Term | Meaning |
|---|---|
| VIBs | Vendor information block (part list). |
| MIID | Maintenance item identification. |
| VPN | Vendor part number. |
| PMT | Part maintenance tree. |
| FT | Figure tree. |
| GFT | Global figure tree (figure tree of entire project). |
| GMLP | Global master list parts (flat list of all maintenance |
| | items in project) |
| GMT | Global maintenance tree (maintenance tree of entire |
| | project). |
| MAC | Maintenance allocation chart. |
| VDCN | Vendor data change notice. |
| WD | Working document. |
| CDRL | Contractual data requirement list. |

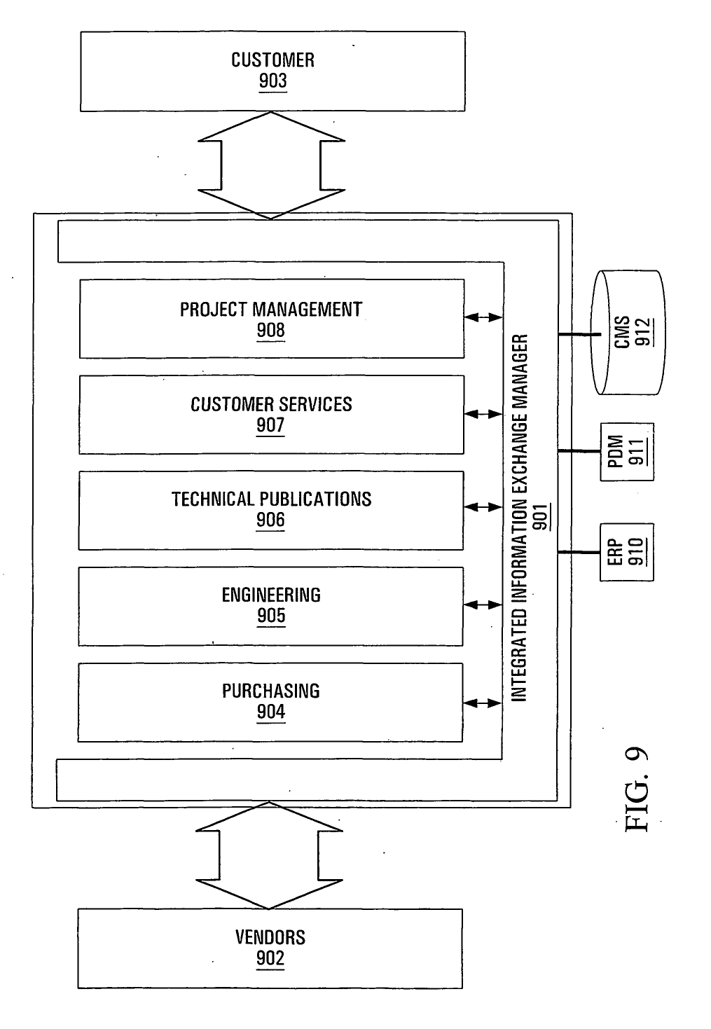

FIG. 9 is a high-level diagram illustrating an additional embodiment consistent with the present invention. In this embodiment, the document center 110 is extended to interact more fully with the internal business processes/divisions of the company hosting the document center 110. The extended document center is referred to as the integrated information exchange manager (IIEM) 901.

Through the electronically published documents, the IIEM links vendors 902, customers 903, and the internal business processes/divisions 904-908. For example, the engineering division 905, after creating the Document Type Definitions (DTDs) and other technical specifications for one or more projects, can directly forward the DTDs to the IIEM 901. Customer orders entered from an electronic parts catalog may be directly forwarded to the purchasing division 904. Similarly, the technical publications division 906, customer services division 907, and project management division 908 are all linked, via IIEM 901, to each other and to the vendors 902 and customers 903. Internal databases and business systems, such as enterprise resource planning (ERP) system 910, product data management (PDM) system 911, and component management system (CMS) 912, may also be linked through IIEM 901.

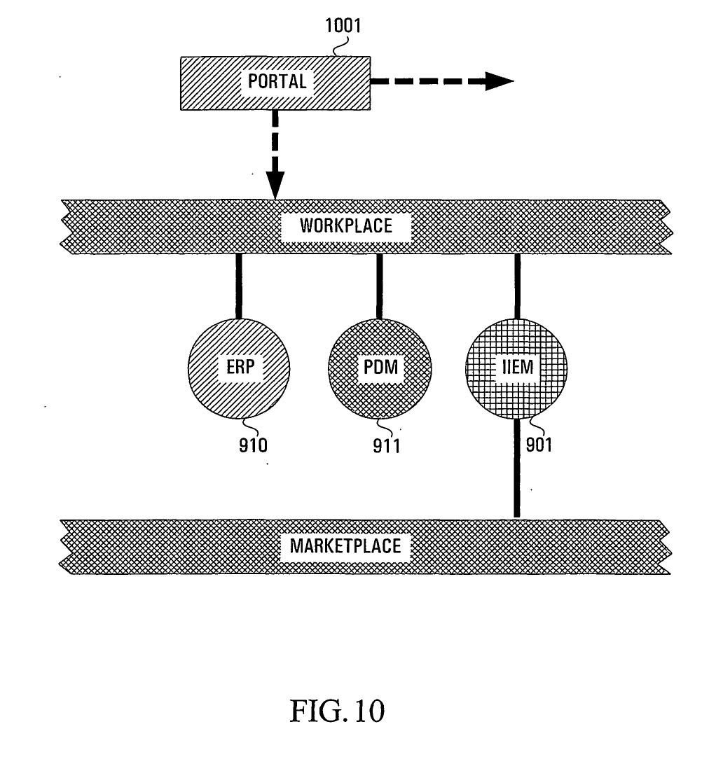

FIG. 10 is a diagram illustrating high-level interaction of customers, vendors, and other parties with the company hosting the IIEM 901. Through web portal 1001, suppliers, partners, and customers may interact with ERP system 910 and PDM system 911. Vendors and other e-commerce partners directly interact with the hosting company through IIEM 901.

The above described systems and methods are capable of generating manuals including constituent components from multiple parties. In comparison to traditional techniques for generating manuals, the above described system is highly efficient, as it is largely automated and allows for data re-use when generating updated versions of a manual or when generating a second manual that uses some or part of the information in the first manual. In addition to data re-use, the data control structures such as the assembly scripts, master document files, and style sheets can often be re-used across different data sets.

The above-described system and method also greatly reduces the time involved in producing the product documentation. Since each vendor 101-102 is responsible for a separate component, several vendors may supply information blocks for those components separately without concern for the integration of their particular blocks with those of other vendors. In other words, since the product manufacturer is concerned with integration, several vendors may provide information blocks in parallel. This differs from the past where vendors typically provided information in serial order because they were charged with responsibility for assuring continuity. Since the vendors may supply information blocks in parallel, the product documentation may be assembled much more rapidly than in the prior art.

It will be apparent to one of ordinary skill in the art that the embodiments as described above may be implemented in many different embodiments of software, and hardware in the entities illustrated in the figures. The actual software code or specialized control hardware used to implement the present invention is not limiting of the present invention. Thus, the operation and behavior of the embodiments were described without specific reference to the specific software code or specialized hardware components, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible consistent with the above teachings or may be acquired from practice of the invention. The scope of the invention is defined by the claims and their equivalents.

We claim:

1. A method of compiling, assembling and distributing a technical document relating to a project, comprising:
receiving from a plurality of vendors component part information describing information for the technical document, each of the plurality of vendors being responsible for documenting a portion of the project;
storing the received component part information at a central location;
automatically generating at least a portion of the technical document by retrieving and organizing elements of the stored component part information, the retrieving and organizing being based on a file describing the desired structure of the technical document; and
distributing the technical document to a customer.

2. A method as defined in claim 1, wherein the technical document is distributed to the customer via a data network.

3. A method as defined in claim 1, further comprising, prior to the receiving, guiding each one of the plurality of vendors in the preparation of respective component part information.

4. A method as defined in claim 3, wherein the preparation of the respective component part information is effected by a guided authoring tool implemented on a computing platform.

5. A method as defined in claim 4, wherein the guided authoring tool guides the preparation of the respective component part information on a basis of a structured document model file.

6. A method as defined in claim 5, wherein the component part information received from each vendor is prepared on the basis of a common structured document model file.

7. A method as defined in claim 6, further comprising preventing each of the plurality of vendors from modifying the structured document model file.

8. A method as defined in claim 7, further comprising, after the receiving, validating the component part information submitted by each of the plurality of vendors.

9. A method as defined in claim 8, wherein validating the component part information includes verifying that the component part information conforms to the structured document model file.

10. A method as defined in claim 9, wherein the structured document model file defines a structure of the component part information, including at least a layout of text in the component part information.

11. A method as defined in claim 10, wherein the validating further includes verifying a nomenclature and coherency of text in the component part information.

12. A method as defined in claim 11, wherein, when the verifying fails to validate a component part information, said method further comprises generating an error message and transmitting the error message to the vendor from whom the component part information was received.

13. A method as defined in claim 10, wherein the structured document model file complies with the standard generalized markup language (SGML) format.

14. A method as defined in claim 13, wherein the structured document model file is an SGML Document Type Definition (DTD).

15. A method as defined in claim 14, wherein the DTD is defined specifically for the project.

16. A method as defined in claim 1, wherein the component part information describes at least one of parts used in the project and maintenance information relating to the described parts.

17. A method as defined in claim 1, further comprising receiving the component part information from one of the vendors and the customer.

18. A method as defined in claim 1, further comprising:
assembling a second technical document relating to the project by automatically generating at least a portion of the second technical document by retrieving and organizing elements of the stored component part information, the retrieving and organizing being based on a second file describing the desired structure of the second technical manual.

19. A method as defined in claim 1, wherein the component part information includes at least one of text, graphical, audio and video information.

20. A method as defined in claim 1, wherein distributing the electronic document to the customer includes providing a web interface through which the customer accesses the technical document, the web interface communicating with internal business processes of the customer.

21. A method as defined in claim 1, wherein each one of the plurality of vendors is associated with a user profile defining vendor access rights.

22. A method as defined in claim 21, further comprising authorizing a particular vendor to submit component part information at least in part on a basis of the user profile associated with the particular vendor.

23. A method as defined in claim 22, further comprising restricting a particular vendor from submitting component part information relevant to a portion of the project for which a different vendor is responsible.

24. A document center comprising:
a data acquisition component configured to receive, from a plurality of vendors, component part information describing information relating to a project, each of the plurality of vendors being responsible for documenting a portion of the project;
a component part repository coupled to the data acquisition component, the component part repository storing the received component part information;
a publication engine coupled to the component part repository, the publication engine operative to generate at least a portion of a technical document describing the project by retrieving and organizing elements in the component part repository, the retrieving and organizing being based on a file describing the desired structure of the technical document; and
a distribution component for distributing the structured technical document to a customer.

25. A document center as defined in claim 24, wherein said publication engine is operative to automatically generate at least a portion of the technical document.

26. A document center as defined in claim 24, further comprising an editor coupled to the component part repository, said editor allowing operators of the document center to modify the stored component part information in the component part repository.

27. A document center as defined in claim 24, wherein the publication engine is further operative to embed hyperlinks in the technical document that link graphical illustrations with textual descriptions corresponding to the graphical illustrations.

28. A document center as defined in claim 24, wherein the distribution component distributes the structured technical document to the customer via a data network.

29. A document center as defined in claim 24, wherein said data acquisition component is operative to guide each one of the plurality of vendors in the preparation of respective component part information.

30. A document center as defined in claim 29, wherein said document center further includes a guided authoring module implemented on a computing platform, the guided authoring module operative to effect preparation of the respective component part information.

31. A document center as defined in claim 30, wherein the guided authoring module guides the preparation of the respective component part information on a basis of a structured document model file.

32. A document center as defined in claim 31, wherein the component part information received at said data acquisition component from each vendor is prepared on the basis of a common structured document model file.

33. A document center as defined in claim 32, wherein said data acquisition component is operative to prevent each of the plurality of vendors from modifying the structured document model file.

34. A document center as defined in claim 33, wherein said data acquisition component includes a validator module for validating the component part information submitted by each of the plurality of vendors.

35. A document center as defined in claim 34, wherein said validator module is operative to verify that the component part information conforms to the structured document model file.

36. A document center as defined in claim 35, wherein the structured document model file defines a structure of the component part information, including at least a layout of text in the component part information.

37. A document center as defined in claim 36, wherein said validator module further verifies the nomenclature and coherency of the text in the component part information.

38. A document center as defined in claim 34, wherein, when said validator module fails to validate a component part information, said validator module is operative to generate an error message and transmit the error message to the vendor from whom the component part information was received.

39. A document center as defined in claim 38, wherein the component part repository is a database that stores the component part elements as standard generalized markup language (SGML) files.

40. A document center as defined in claim 39, wherein the structured document model file complies with the SGML format.

41. A document center as defined in claim 40, wherein the structured document model file is an SGML Document Type Definition (DTD).

42. A document center as defined in claim 41, wherein the DTD is defined specifically for the project.

43. A document center as defined in claim 24, wherein the component part elements describe at least one of parts used in the project and maintenance information relating to the described parts.

44. A document center as defined in claim 24, wherein the component part information includes at least one of text, graphical, audio and video information.

45. A document center as defined in claim 24, wherein the distribution component includes a web interface through which the customer accesses the technical document, the web interface communicating with internal business processes of the customer.

46. A method of producing a technical manual describing an engineering project, comprising:
receiving, from vendors responsible for portions of the engineering project, a list of parts used by the vendor, a hierarchical structure describing maintenance information relating to the parts in the list, and a hierarchical structure describing relationships between illustrations of the parts in the list;
storing a plurality of Standard Generalized Markup Language (SGML) files, each of the files containing content relating to at least one aspect of the engineering project, relationships between the SGML files being described by the hierarchical structure describing maintenance information relating to the parts in the list and the hierarchical structure describing relationships between illustrations of the parts in the list; and
assembling information from select ones of the plurality of SGML files into the technical manual having an organization based on pre-defined files describing the desired structure and content of the technical manual,
wherein the SGML files include information describing at least one of parts used in the engineering product and maintenance schedules relating to the described parts.

47. A method as defined in claim 46, further comprising:
distributing the technical manual electronically to a customer via a data network.

48. A method as defined in claim 46, wherein the SGML files conform to an SGML document type definition (DTD) defined specifically for the project.

49. A method as defined in claim 46, wherein the SGML files describe parts used in the project and maintenance information relating to the described parts.

50. A method as defined in claim 48, further comprising receiving SGML files from the customer.

51. A method as defined in claim 50, further comprising, prior to the receiving, guiding each one of the plurality of vendors in the preparation of respective SGML files.

52. A method as defined in claim 51, wherein the preparation of the respective SGML files is effected by a guided authoring tool implemented on a computing platform.

53. A method as defined in claim 52, wherein the guided authoring tool guides the preparation of the respective SGML files on a basis of the DTD defined specifically for the project.

54. A method as defined in claim 53, further comprising preventing each of the plurality of vendors from modifying the DTD defined specifically for the project.

55. A method as defined in claim 50, further comprising, after the receiving, validating the SGML files submitted by each of the plurality of vendors.

56. A method as defined in claim 55, wherein validating a SGML file includes verifying that the SGML file conforms to the DTD defined specifically for the project.

57. A method as defined in claim 56, wherein the DTD defines a structure of the SGML file, including at least a text layout of the content of the SGML file.

58. A method as defined in claim 57, wherein the validating further includes verifying a nomenclature and coherency of the text in the SGML file.

59. A method as defined in claim 58, wherein, when the verifying fails to validate an SGML file, said method further comprises generating an error message and transmitting the error message to the vendor from whom the SGML file was received.

60. A method as defined in claim 46, further comprising:
assembling a second technical manual relating to the project by automatically generating at least a portion of the second technical manual by retrieving and organizing elements of the SGML files, the retrieving and organizing being based on a second set of pre-defined files describing the desired structure of the second technical manual.

61. A method as defined in claim 46, wherein the SGML files reference at least one of text, graphical, audio and video information.

62. A method as defined in claim 46, wherein distributing the technical manual to the customer includes providing a web interface through which the customer accesses the technical manual, the web interface communicating with internal business processes of the customer.

63. In combination:
a network server comprising:
a processor;
a memory including:
a component part repository for storing component part information describing information relating to a project;
a master file describing the desired structure of a technical document;
a program element including individual instructions, said program element implementing:
a data acquisition component configured to receive, from a plurality of vendors, component part information for storage in said component part repository, each of the plurality of vendors being responsible for documenting a portion of the project;
a publication engine operative to automatically generate at least a portion of the technical document describing the project by retrieving and organizing elements in the component part repository, the retrieving and organizing being based on the master file stored in said memory; and
a workstation remote from said network server and in data communication with said network server, said workstation comprising:
a guided authoring tool implemented on a computing platform for guiding at least one of the plurality of vendors in the preparation of respective component part information, said guided authoring tool guiding the preparation of the respective component part information on a basis of a structured document model file, said guided authoring tool operative to interact with said data acquisition component to forward to said data acquisition component the respective component part information.

64. A workstation implementing:
a graphical user interface; and
a guided authoring tool for guiding a vendor in the preparation of an electronic document intended for integration with other electronic documents to form a technical manual;
said guided authoring tool being responsive to user inputs to generate the electronic document;
said guided authoring tool including a structured document model file that establishes a structure of the electronic document, including at least a predetermined text layout;
said workstation operative to issue signals directed to a remote network server to forward to the network server data representing the electronic document;
said workstation being responsive to signals issued by the network server containing data indicating that data forwarded to the network server from said workstation is invalid to display an error message to the vendor via said graphical user interface.
